(19) United States
(12) Patent Application Publication
(10) Pub. No.: US 2005/0100098 A1
(43) Pub. Date: May 12, 2005

(54) HIGHLY INTEGRATED MPEG-4 VIDEO DECODING UNIT

(76) Inventors: Gong-Sheng Lin, Tai-Chung City (TW); Hui-Hua Kuo, Tai-Nan City (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,744

(22) Filed: Oct. 23, 2003

(51) Int. Cl. H04N 7/12

(52) U.S. Cl. 375/240.25; 375/240.12

(57) ABSTRACT

A highly integrated MPEG-4 video decoding unit includes switching circuit, a set of decoding modules, and a memory. The set of decoding modules includes a plurality of decoding modules, each capable of decoding a predetermined signal in each of a plurality of VOP types. The decoding module may include a VOP type indicating flag that is set by the switching circuit so that the correct lookup table can be used during decoding of the predetermined signal. Alternatively, the necessary lookup table(s) may be electronically transferred to the corresponding decoding module. According to the type of VOP being decoded, the switching circuit may send a predetermined sequence of selection signals to a multiplexer so that the decoded results from appropriate decoding modules are stored into the corresponding storage elements in the memory.

### BACKGROUND OF INVENTION

1. Field of the Invention

The present invention relates to a video decoding unit. More specifically, a highly integrated MPEG-4 video decoding unit and a method for decoding MPEG-4 video is disclosed.

2. Description of the Prior Art

MPEG-4 is an ISO/IEC standard developed by MPEG (Moving Picture Experts Group) proven to be beneficial in digital television, interactive graphics, and interactive multimedia. Unlike its successors, MPEG-1 and MPEG-2 that basically standardized a way to sequentially present a series of pictures to the user, MPEG-4 represents a totality of possibly multiple media objects, each of which may be real or generated by a computer. The media objects are described and synchronized in such a way that they can be combined to form compound audiovisual scenes easily transmitted over a network.

Several layers of video coding hierarchy are required to implement MPEG-4. At the top is a Video Object Sequence (VS) that contains all the media objects making up the complete visual scene. Next is a Video Object (VO) that represents one of the media objects in the scene. Under the VO is a Video Object Layer (VOL) that provides scalalbe coding and a full MPEG-4 header VOL or a short header VOL. Under the VOL is a Video Object Plane (VOP), which is a sample of the VO at a moment in time, contains motion, shape, and texture information, and obviously requires proper decoding to generate a visual scene for presentation to the viewer.

There are several types of VOPs, commonly known as I (Intra), P (Predicted), and B (Bi-directional) pictures. An I picture (I-VOP) is self-contained and is encoded independently of any other VOPs. A P picture (P-VOP) is encoded using another previous VOP and motion compensation. A B picture (B-VOP) also uses motion compensation and is interpolated using other I-VOPs or P-VOPs and in either or both directions relative to the video stream. Additionally, the MPEG-4 specification provides for two additional types of VOPs. These two additional VOPs are similar to I-VOP and P-VOP frames except that they are Data-partitioned. Data-partitioned I-VOPs and P-VOPs are signaled by the VOL and separate the motion information from the texture information to localize error at the decoder and improve performance.

Decoding of VOPs is a complicated process often entailing different decoding modules for different types of VOPs. Please refer to FIG. 1 for a description of a first loop in the decoding process of combined VOPs, defined here as non-Data-partitioned VOPs (I-VOPs, P-VOPs, and B-VOPs that are not Data-partitioned). The combined VOP first decoding loop 10 in FIG. 1, which handles macroblock related data, comprises a set 15 of decoding modules, each decoding module in the set 15 decoding a specific portion or signal of the VOPs macroblock and storing the result in a memory 30 for further processing.

A decoding module 20 is provided for interpreting the signals mcbpc, or if not coded, mcsel. The mcbpc is a variable length code used with a lookup table to derive the macroblock type and the coded block pattern for chrominance. The decoded mcbpc (or mcsel) is then stored in a storage element 32 of the memory 30. A decoding module 22 is provided for the signals ac_pred_flag and cbpy. The ac_pred_flag is a 1-bit flag that indicates that either the first row or the first column of AC coefficients are differentially coded for Intra coded macroblocks. The signal cbpy is a variable length code representing a pattern of non-transparent luminance blocks with at least 1 non Intra DC transform coefficient in a macroblock and is interpreted with another lookup table. The data is then stored in a storage element 34 of the memory 30.

Similarly, decoding module 24 for decoding the signal dquant, decoding module 26 for decoding interlaced information, and decoding module 28 for decoding motion vectors also store the results of the decoding process into storage elements 36, 38, and 40 respectively. All three of these signals are 2-bit codes that specify changes in the quantizer. Again, the use of another lookup table is employed in obtaining the results that are stored in the memory 30.

Now, please refer to FIG. 2 that is a diagram illustrating a second decoding loop 50 for block-related data for combined VOPs. The second decoding loop 50 comprises a set 45 of decoding modules and a corresponding set of storage elements in a memory 60. Obviously, the memory 60 can be combined with the memory 30.

The set 45 comprises a decoding module 52 for decoding the signals dct_dc_size_lum, dct_dc_size_chrominance, and dct_dc_size_differential. These three signals are variable length codes used to respectively derive differential DC coefficients of luminance, differential DC coefficients of chrominance, and differential DC coefficients in Intra macroblocks. Again, each value is obtained utilizing lookup tables and stored into a storage element 58 in the memory 60. The set 45 additionally comprises a decoding module 54 for AC coefficients according to the results obtained from the decoding module 22 of FIG. 1. The results of the decoding process are then stored into a storage element 62.

The decoding of Data-partitioned I-VOPs and P-VOPs each require a separate pair of decoding loops. The decoding loops for Data-partitioned I-VOPs are illustrated in FIG. 3 and FIG. 4 and the pair of decoding loops for Data-partitioned P-VOPs are illustrated in FIG. 5 and FIG. 6 respectively.

In FIG. 3, a first macroblock decoding loop 88 comprises a set 70 of decoding modules and a memory 80. A decoding module 72 has a similar function to the decoding module 20 but may utilize different lookup tables. The results are stored into a storage element 82 of the memory 80. A decoding module 74 has a similar function to the decoding module 24 but also may utilize different lookup tables. The results are stored into a storage element 84. A decoding module 76 has a function similar to the decoding module 52, but may use different lookup tables, and a storage element 86 receives the result. The set 70 also includes a module for checking a dc_marker, a constant 19-bit binary string present in Data-partitioned I-VOPs.

FIG. 4 illustrates a second decoding loop 90 for Data-partitioned I-VOPs and comprises a set of decoding modules 92 and a memory 94. A decoding module 96 performs a function similar to that of the decoding module 22 using different lookup tables, and stores the result into a storage element 102 of the memory 94. A macroblock number checking module is also present in the set 92. A decoding module 100 functions similarly to the decoding module 54 and places the results into a storage element 104.

Turning now to FIG. 5, a first decoding loop 110 in the macroblock decoding process for Data-partitioned P-VOPs will be described. Again, the first decoding loop 110 comprises a set of decoding modules 112 and a memory 114. A decoding module 116 performs a similar function to that of the module 70 (different lookup tables) and stores the result in a storage element 122. A decoding module 118 functions similarly to the decoding module 28 and places the result in a storage element 124. Also included in the set 112 is a module 120 that checks for a fixed 17-bit string, known as a motion_marker, present in Data-partitioned P-VOPs.

A memory 134 and a set of decoding modules 132 of a second decoding loop 130 for Data-partitioned P-VOPs are illustrated in FIG. 6. A decoding module 136 functions similarly to the decoding module 22 (different lookup tables) and stores the results into a storage element 146 of the memory 134. A decoding module 138 is similar to the decoding module 52 (different lookup tables) and stores its results into a storage element 148. At the block level, a decoding module 144 functions similarly to the decoding module 54 according to results obtained earlier and stores the AC coefficients into a storage element 150 of the memory 134. A macroblock number checking module is also present in the set 132.

The success of MPEG-4 is a testimonial to the effectiveness of utilizing the six decoding loops, six sets of decoding modules, and six sets of memory storage elements briefly outlined above and as laid out by the MPEP-4 specification. All said sets are required to fully comply with the MPEG-4 standard. However, implementation of MPEG-4 decoding modules as described above results in high cost, complexity, and chip size.

### SUMMARY OF INVENTION

It is therefore a primary objective of the claimed invention to reduce the cost, complexity, and chip size of an apparatus for decoding MPEG-4 by disclosing a highly integrated MPEG-4 video decoding unit.

The claimed invention includes three primary structures, a VOP decoding switching circuit, a set of decoding modules, and a memory. The set of decoding modules includes a plurality of decoding modules, most of which are each capable of providing multiple functions during decoding. The multi-functioned decoding modules decode a predetermined signal in each of a predetermined plurality of VOP types and output a decoded result specifically corresponding to the VOP type currently being decoded. The predetermined plurality of VOP types may at least include Data-partitioned Intra VOPs and Data-partitioned Predicted VOPs as defined by the MPEG-4 specification and may also include combined I-VOPs, combined P-VOPs, and combined B-VOPs.

A VOP may be sent to the set of decoding modules via the VOP decoding switching circuit. According to the type of VOP being decoded, the VOP decoding switching circuit may then send a predetermined sequence of selection signals to a multiplexer that is connected between the decoding modules and the memory so that the appropriate decoded results are stored into the corresponding storage elements in the memory.

The claimed decoding module may allow for the storage of the lookup table needed for decoding the predetermined signal in more than one type of VOP. Here, the decoding module may include a VOP type indicating flag that is set by the VOP decoding switching circuit. During decoding of a VOP, the decoding module can select the correct lookup table according to the value of the VOP type indicating flag. If the next VOP to be decoded by the decoding module is of a different type, the VOP type indicating flag is then set to the new VOP type indicating that the decoding module is to access a different lookup table.

In another example of the claimed invention, each decoding module includes at least enough memory to store the largest lookup table that will be used by that decoding module. Upon determination by the VOP decoding switching circuit of which type of VOP is to be decoded, the necessary lookup table(s) may be electronically transferred to the corresponding decoding module. Once the decoding module has received the corresponding lookup table, decoding can be completed for that predetermined signal. If the next VOP to be decoded is of a different type, and therefore requiring a different lookup table, the necessary lookup table or tables for that VOP type are then transferred to the decoding module.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a first decoding loop for combined VOPs according to the prior art.

FIG. 2 is a functional block diagram of a second decoding loop for combined VOPs according to the prior art.

FIG. 3 is a functional block diagram of a first decoding loop for Data-partitioned I-VOPs according to the prior art.

FIG. 4 is a functional block diagram of a second decoding loop for Data-partitioned I-VOPs according to the prior art.

FIG. 5 is a functional block diagram of a first decoding loop for Data-partitioned P-VOPs according to the prior art.

FIG. 6 is a functional block diagram of a second decoding loop for Data-partitioned P-VOPs according to the prior art.

FIG. 7 is a functional block diagram of an MPEG-4 video decoding unit according to the present invention.

### DETAILED DESCRIPTION

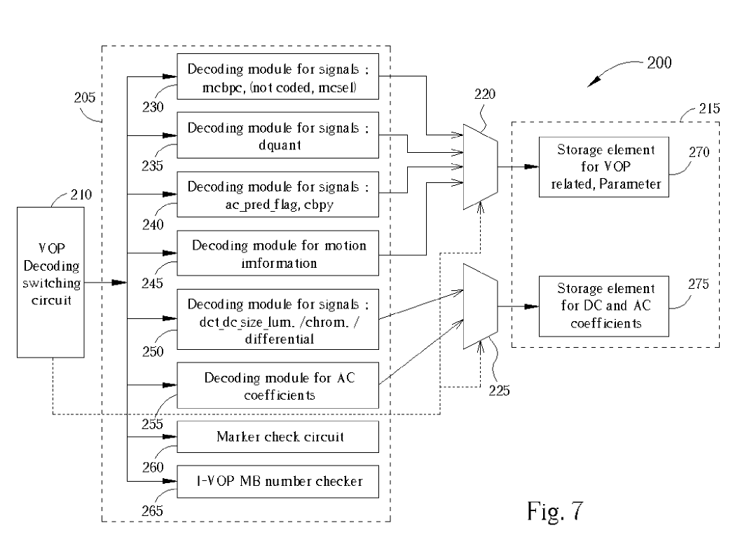

The present invention discloses a highly integrated MPEG-4 video decoding unit and method for decoding MPEG-4 video. The claimed method and apparatus greatly reduces the required number of decoding modules required by the prior art while retaining their functionality. FIG. 7 is a functional block diagram of an MPEG-4 video decoding unit 200 according to the present invention.

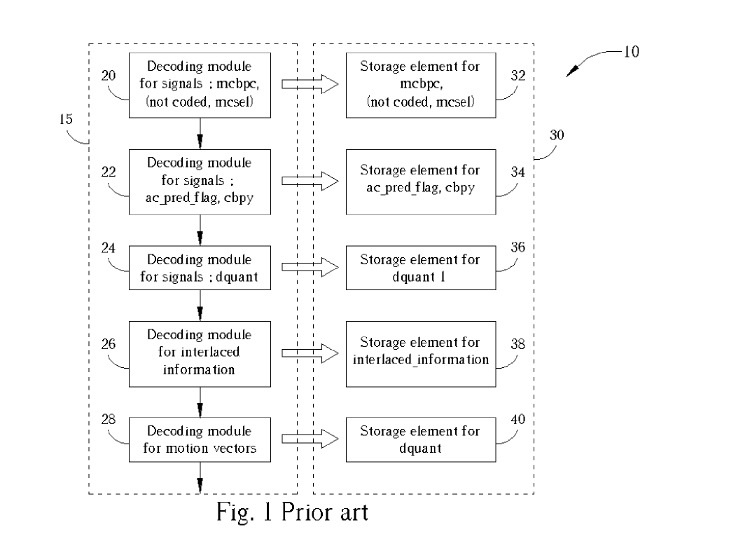

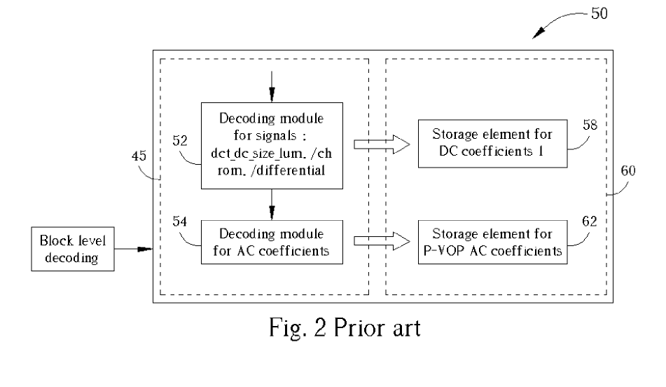

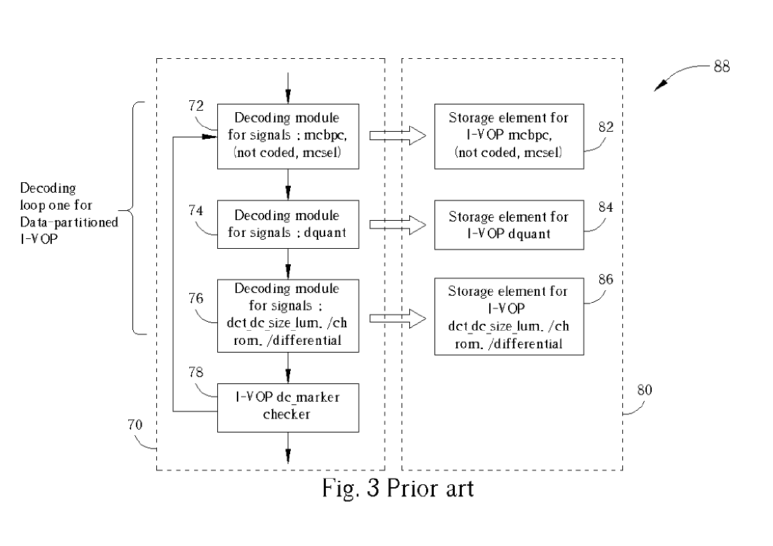

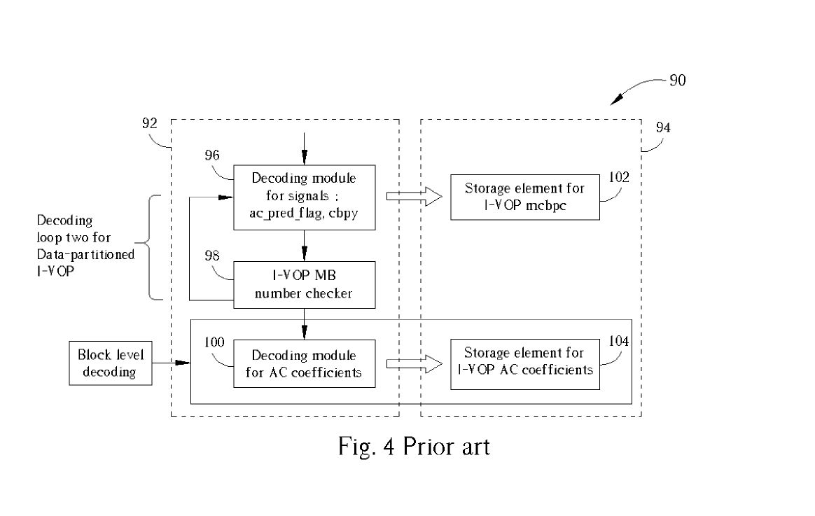

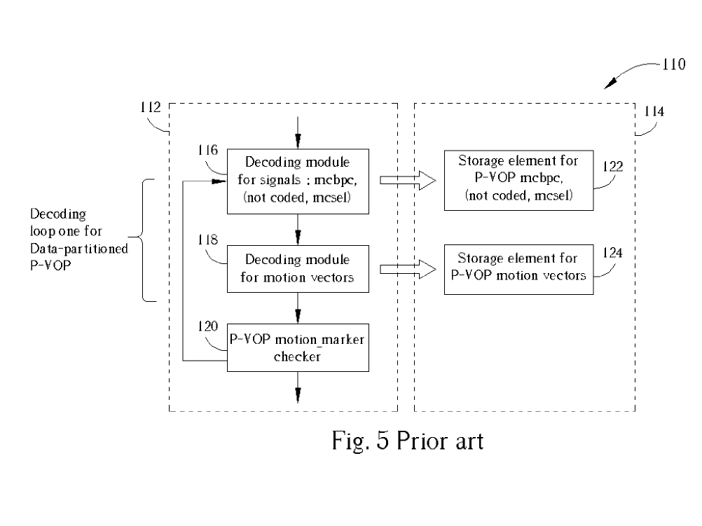

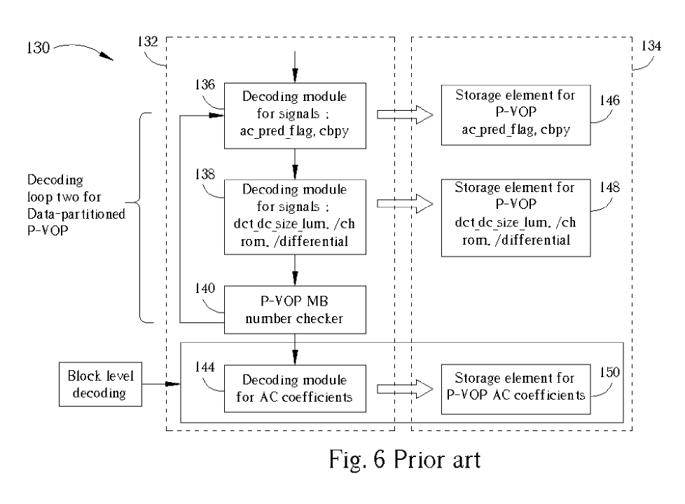

The video decoding unit 200 comprises three primary structures, the VOP decoding switching circuit 210, a set 205 of decoding modules, and a memory 215 for storing the results outputted from the set 205 of decoding modules. The memory 215 may optionally be subdivided into a plurality of regions 270 and 275 segregated by result type as shown in FIG. 7, however memory arrangement is not critical to the spirit of the invention. The number of memory regions 270 and 275, along with the number of corresponding multiplexers 220 and 225 that control input to the memory regions 270 and 275, are merely illustrated as in FIG. 7 to correspond with the two loop groupings (first and second decoding loops) of storage elements already discussed concerning FIG. 1 through FIG. 6.

The set 205 of decoding modules comprises a plurality of decoding modules, most of which are each capable of providing multiple functions during decoding. A decoding module 230 for signals performs the various functions provided by the prior art decoding modules 20, 72, and 116, with the respective results transmitted through the multiplexer 220 into an appropriate storage element 270 in the memory 215 for further processing. A decoding module 235 provides both the functions previously provided by the prior art decoding modules 24 and 74, routing the ensuing results through the multiplexer 220 into the storage element 270. A decoding module 240 supplies the functions of the prior art decoding modules 22, 96, and 136, storing the resulting into the storage element 270 via the multiplexer 220. A single decoding module 245, replaces the prior art decoding modules 26, 28, and 118, with the storage element 270 again receiving the results through the multiplexer 220, provides motion information. The decoding module 245 may also be utilized to decode the interlaced information of the prior art decoding module 26 or an additional (not shown) module may be optionally added. Luminance, chrominance, and differential signals are decoded in a decoding module 250 and provide the functions previously provided by decoding modules 52, 76, and 138. The respective results are stored into a storage element 275 via a multiplexer 225. A decoding module 255 that replaces the prior art decoding modules 54, 100, and 144 decodes AC coefficients. The results are transmitted through the multiplexer 225 into the storage element 275. A marker checking module 260 replaces the prior art decoding modules 78 and 120. In addition, a macroblock number checker module 265 performs the functions previously requiring decoding modules 98 and 140.

As can be understood from FIG. 7, a VOP is sent to the set 205 of decoding modules via the VOP decoding switching circuit 210. According to the type of VOP being decoded, the VOP decoding switching circuit 210 may then send a predetermined sequence of selection signals to the multiplexers 220 and 235 so that the appropriate decoded results are stored into the corresponding storage elements 270 and 275.

As stated in the prior art section of this disclosure, different types of VOPs may require different lookup tables uniquely corresponding to the specific type of VOP being decoded by any given decoding module at any given time. The present invention eliminates unneeded decoding circuitry while overcoming this incompatibility issue of the prior art in at least two ways.

One embodiment of the present invention allows for the storage of all of the lookup information needed for a specific decoding function corresponding to more than one type of VOP in the decoding module responsible for that function. For example, the decoding module 230 may store the lookup table for decoding the mcbpc signal in an I-VOP and the lookup table for decoding the mcbpc signal in a P-VOP. The type of VOP currently being decoded obviously determines the decision of which lookup information is used during the decoding process. One possible implementation of this decision is for the decoding module 230 to comprise a VOP type indicating flag that is set internally or by the VOP decoding switching circuit 210. During decoding of a VOP, the decoding module 230 can select the correct lookup information according to the value of the VOP type indicating flag. If the next VOP to be decoded by the decoding module is of a different type, the VOP type indicating flag is then set to the new VOP type indicating that the decoding module is to access a different lookup table.

Another embodiment of the present invention overcomes the prior art incompatibility issue in another manner. Each decoding module comprises at least enough memory to store the largest lookup table that will be used by that decoding module. Upon determination by the VOP decoding switching circuit 210 of which type of VOP is to be decoded, the necessary lookup tables may be electronically transferred to the corresponding decoding module. Once the decoding module has received the corresponding lookup table, decoding can be completed for that predetermined signal. If the next VOP to be decoded is of a different type, and therefore requiring a different lookup table, the necessary lookup table or tables for that VOP type are then transferred to the decoding module or possibly fetched by the decoding module from the VOP decoding switching circuit 210 or alternate source.

The highly integrated MPEG-4 video decoding unit of the present invention provides all of the functionality of the prior art decoding units while greatly reducing the necessary hardware and associated costs. Individual decoding modules are designed to decode specific signals occurring in the VOPs. The specific signals are interpreted correctly according to the type of VOP being currently decoded. A switching circuit may be employed to indicate to the respective decoding modules which type of VOP is to be decoded by that decoding module. Furthermore, the switching circuit may be connected to a multiplexer to control delivery of the decoded results from each decoding circuit to a storage element in memory. Obviously, not all decoding modules need to be decoding the same VOP or the same VOP type simultaneously. As such, the switching circuit may be designed to maximize throughput by efficient selection and assignment of VOPs to the individual decoding units.

Those skilled in the art will readily observe that numerous modifications and alterations of the device and method may be made while retaining the teachings of the invention Accordingly, the above disclosure should be construed as limited only by the metes and bounds of the appended claims.

1. A video decoding unit for decoding a predetermined plurality of different video object plane (VOP) types, the decoding unit comprising:
at least one decoding module capable of decoding a predetermined signal in each of the predetermined plurality of different VOP types and outputting a decoded result specifically corresponding to the VOP type currently being decoded.

2. The video decoding unit of claim 1 wherein the decoded result is based upon a predetermined lookup table specifically corresponding to the VOP type currently being decoded.

3. The video decoding unit of claim 2 wherein the predetermined lookup table specifically corresponding to the VOP type currently being decoded is selected from a plurality of predetermined lookup tables specifically and respectively corresponding to the predetermined plurality of VOP types.

4. The video decoding unit of claim 3 further comprising a switching circuit connected to the decoding module for determining which of the predetermined plurality of VOP types the decoding module is to decode.

5. The video decoding unit of claim 4 further comprising a multiplexer having an input connected to an output of the decoding module for selectively outputting the coded result to a memory for further processing.

6. The video decoding unit of claim 5 wherein the output of the multiplexer is determined by the switching circuit.

7. The video decoding unit of claim 4 wherein the decoding module comprises a VOP type indicating flag.

8. The video decoding unit of claim 7 wherein the VOP type indicating flag is set by the switching circuit.

9. The video decoding unit of claim 4 wherein the predetermined lookup table specifically corresponding to the VOP type the decoding module is to decode is transmitted from the switching circuit to the decoding module.

10. A device comprising:
a memory;
a plurality of video decoding modules, each video decoding module capable of decoding a predetermined signal in a Data-partitioned intra video object plane (DP-I VOP) and capable of decoding the predetermined signal in a Data partitioned predicted video object plane (DP-P VOP) and outputting a decoded result according to the type of VOP;
a multiplexer having inputs respectively connected to outputs of the plurality of video decoding modules and having an output connected to the memory; and
a switching circuit connected to the plurality of video decoding modules for indicating to each decoding module which type of VOP is to be decoded and connected to the multiplexer for controlling which decoded result is transmitted to the memory.

11. The device of claim 10 wherein the decoded result is determined by data specifically corresponding to the VOP type currently being decoded.

12. The device of claim 11 wherein the data specifically corresponding to the VOP type currently being decoded is selected from a predetermined lookup table corresponding to a DP-I VOP or is selected from a predetermined lookup table corresponding to a DP-P VOP.

13. The device of claim 12 wherein the predetermined lookup table specifically corresponding to the VOP type the decoding module is to decode is transmitted from the switching circuit to the decoding module.

14. The device of claim 10 wherein each decoding module comprises a VOP type indicating flag.

15. The device of claim 13 wherein the VOP type indicating flag is set by the switching circuit.

16. A method for decoding a plurality of different types of MPEG video object planes (VOP), the method comprising:
providing a decoding module capable of decoding a predetermined signal in the different types of VOP;
indicating to the decoding module which of the different types of VOP the decoding module is to decode; and
the decoding module accessing a lookup table specifically corresponding to the indicated type of VOP to decode the predetermined signal.

17. The method of claim 16 wherein each of the plurality different types of VOP corresponds to a different lookup table.

18. The method of claim 16 wherein the decoding module comprises a VOP type indicating flag and the method further comprises setting the VOP type indicating flag to indicate which of the different types of VOP the decoding module is to decode.

19. The method of claim 18 wherein the VOP type indicating flag is set by a switching circuit.

20. The method of claim 16 wherein the type of VOP the decoding module is to decode is indicated by a switching circuit transmitting the corresponding lookup table to the decoding module.
